(19) United States
(12) Patent Application Publication
(10) Pub. No.: US 2026/0328239 A1
(43) Pub. Date: Oct. 22, 2026

(54) SELF-DRILLING SCREW WITH AT LEAST ONE TAB

(71) Applicant: SUN THROUGH INDUSTRIAL CO., LTD., Changhua County (TW)

(72) Inventors: Wei-Ju WANG, Changhua County (TW); Wu-Chieh WANG, Changhua County (TW)

(21) Appl. No.: 19/356,295

(22) Filed: Oct. 13, 2025

(30) Foreign Application Priority Data
Mar. 17, 2025 (TW) 114109927

(51) Int. Cl. F16B 25/10; F16B 25/00

(52) U.S. Cl. CPC F16B 25/103; F16B 25/0031

(57) ABSTRACT

A self-drilling screw with at least one tab contains a stem, a screw head, a drill portion, and the at least one tab. The stem includes a threaded section formed on an outer wall thereof. The screw head is formed on an end of the stem. The drill portion is formed on the other end of the stem. The at least one tab is located on the stem adjacent to the drill portion and the threaded section, and the stem includes two indentations formed on two sides of each tab. Each tab includes a thicker sheet that has multiple auxiliary teeth formed on a side of the thicker sheet away from the stem and connected with a thinner flange. A profile of the multiple auxiliary teeth corresponds to a profile of the threaded section, and the multiple auxiliary teeth are spaced by the threaded section.

### TECHNICAL FIELD

The present invention relates to a screw, and more particularly to a self-drilling screw with at least one tab.

### BACKGROUND

Conventional self-drilling screws are a type of fastener widely used in the fields of construction, furniture, machinery manufacturing, etc. They have the characteristics of self-drilling and self-tapping. They are particularly suitable for locking composite materials of soft and hard materials at the same time, such as the laminated structure of wood (or acrylic, plastic, etc.) and metal plates.

With reference to FIGS. 13-15, a conventional self-drilling screw contains a stem 91 with a threaded section 911 formed on an outer wall of the stem 91; a screw head 92 connected on an end of the stem 91 and connected with the threaded section 911; a drill portion 93 formed on the other end of the stem 91 and connected with the threaded section 911; and at least one tab 94 formed on two sides of the stem 91 adjacent to the drill portion 93 and located on the drill portion 93; wherein two tabs 94 are provided and formed in a sheet shape with a same thickness, wherein the two tabs 94 are extrusion formed so that two indentations 912 are defined on the stem 91 and located besides each tab 94.

As shown in FIGS. 16-19, when a workpiece 70 made of wood is screwed with another workpiece 80 made of metal, the drill portion 93 abuts against the workpiece 70, and the screw head 92 is rotated to drive the drill portion 93 to drill a locking orifice 71 on the workpiece 70, and the two tabs 94 are moves into the locking orifice 71 with the drill portion 93, such that the threaded section 911 moves into the locking orifice 71 smoothly. When the drill portion 93 drills across the workpiece 70 and into the workpiece 80 further, a fixing orifice 81 is formed, and the threaded section 911 taps the fixing orifice 81. When the two tabs 94 contact the workpiece 80, the two tabs 94 are stopped and then break. Hence, the threaded section 911 taps and screws into the fixing orifice 81 until the screw head 92 abuts against the workpiece 70, thus connecting the workpiece 70 to the workpiece 80.

However, when the two tabs 94 is broken and removed during drilling and screwing the workpieces by using the self-drilling screw, a non-threaded area 913 forms on a broken portion and has an angle greater than 90 degrees, hence a taping will cause a greater labor consumption for a user, thus increasing a screwing difficulty, prolonging a locking time, and reducing working efficiency. After the two tabs 94 are broken and removed, a zone from which the two tabs 94 lose a circumferential support, so only the upper and lower points of the threaded section 911 are in contact with the circumference. A tilted result occurs in a tapping process for the self-drilling screw, thus influencing the screwing and locking stability and posing an unexpected danger.

The present invention has arisen to mitigate and/or obviate the afore-described disadvantages.

### SUMMARY

The primary aspect of the present invention is to provide a self-drilling screw with at least one tab by which when the workpiece made of the wood is connected with another workpiece made of the metal, the flange is broken so that the multiple auxiliary teeth of the thicker sheet expose outside, and the multiple auxiliary teeth and the threaded section drill continuously to reduce a screwing difficulty, shorten a screwing force and time, and enhance working efficiency.

Another primary aspect of the present invention is to provide a self-drilling screw with at least one tab which is capable of preventing a tilted drilling of the workpieces, thus enhancing screwing stability and avoiding a using danger.

To obtain the above-mentioned aspects, a self-drilling screw with at least one tab provided by the present invention contains a stem, a screw head, a drill portion, and the at least one tab.

The stem includes a threaded section formed on an outer wall thereof.

The screw head is formed on an end of the stem.

The drill portion is formed on the other end of the stem.

The at least one tab is located on the stem adjacent to the drill portion and the threaded section, and the stem includes two indentations formed on two sides of each tab of the at least one tab. Each tab further includes a thicker sheet which has multiple auxiliary teeth formed on a side of the thicker sheet away from the stem and connected with a thinner flange. A profile of the multiple auxiliary teeth corresponds to a profile of the threaded section, and the multiple auxiliary teeth are spaced by the threaded section.

### BRIEF DESCRIPTION OF THE DESIGN DRAWINGS

FIG. 1 is a perspective view showing the assembly of a self-drilling screw with at least one tab according to a preferred embodiment of the present invention.

FIG. 2 is a side plan view showing the assembly of a part of the self-drilling screw according to the preferred embodiment of the present invention.

FIG. 3 is a cross-sectional view taken along the line A-A of FIG. 2 according to the preferred embodiment of the present invention.

FIG. 4 is a cross-sectional view showing the operation of the self-drilling screw according to the preferred embodiment of the present invention.

FIG. 5 is another cross-sectional view showing the operation of the self-drilling screw according to the preferred embodiment of the present invention.

FIG. 6 is also another cross-sectional view showing the operation of the self-drilling screw according to the preferred embodiment of the present invention.

FIG. 7 is still another cross-sectional view showing the operation of the self-drilling screw according to the preferred embodiment of the present invention.

FIG. 8 is another cross-sectional view showing the operation of the self-drilling screw according to the preferred embodiment of the present invention.

FIG. 9 is a side plan view showing the assembly of a part of a self-drilling screw with at least one tab according to another preferred embodiment of the present invention.

FIG. 10 is another side plan view showing the assembly of the part of the self-drilling screw according to another preferred embodiment of the present invention.

FIG. 11 is a side plan view showing the assembly of a part of the self-drilling screw according to another preferred embodiment of the present invention.

FIG. 12 is a cross-sectional view showing the operation of a part of the self-drilling screw according to another preferred embodiment of the present invention.

FIG. 13 is a perspective view of a conventional self-drilling screw.

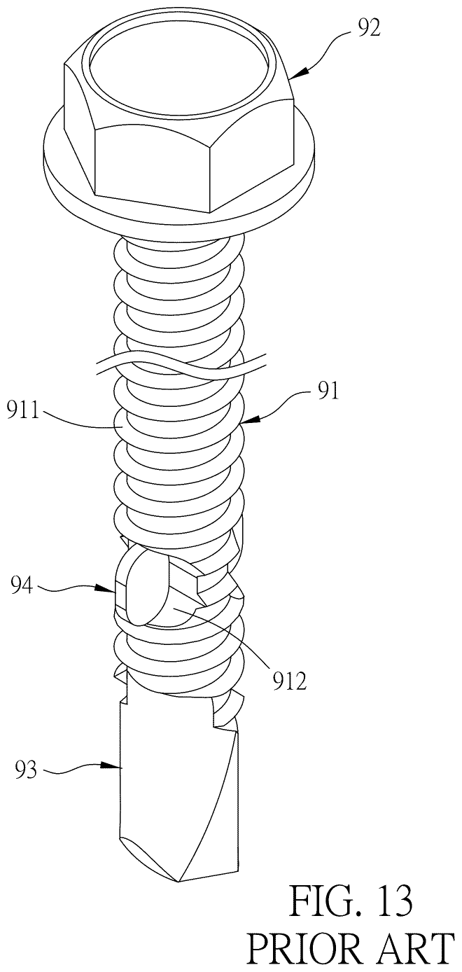

FIG. 14 is a side plan view of the conventional self-drilling screw.

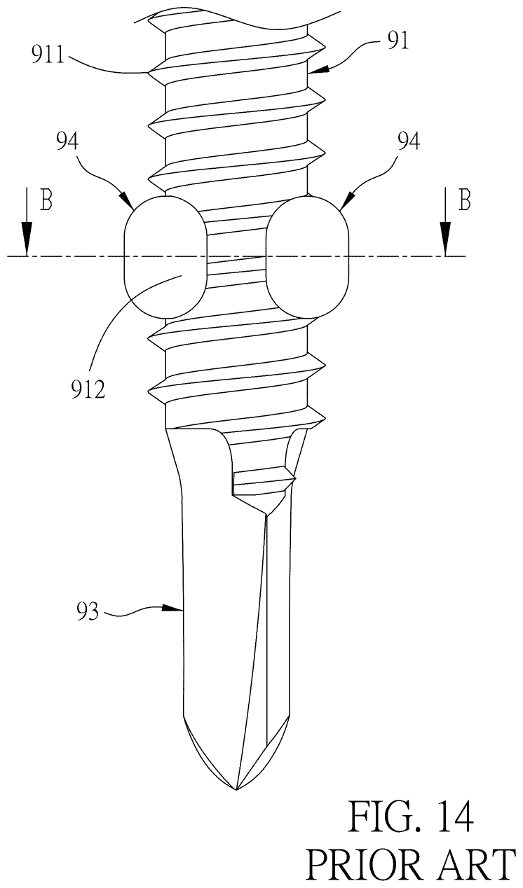

FIG. 15 is a cross-sectional view taken along the line B-B of FIG. 13.

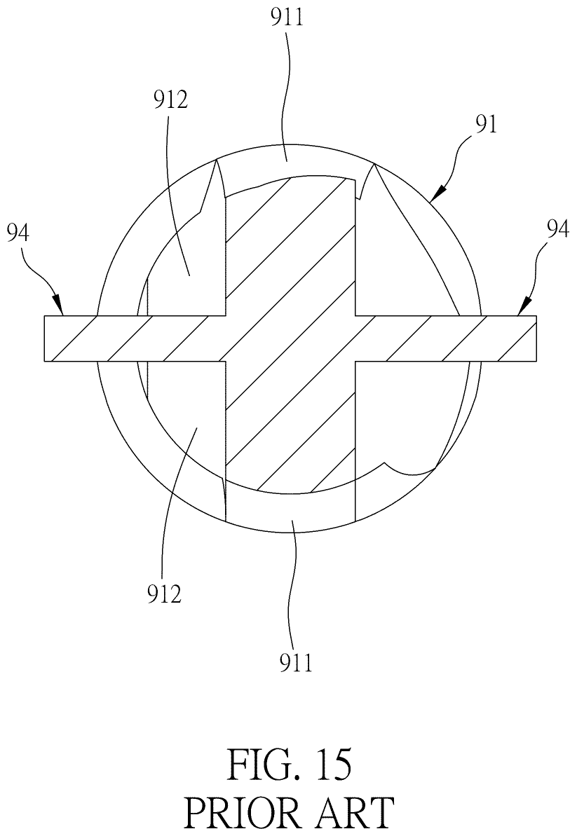

FIG. 16 is a cross-sectional view showing the operation of the conventional self-drilling screw.

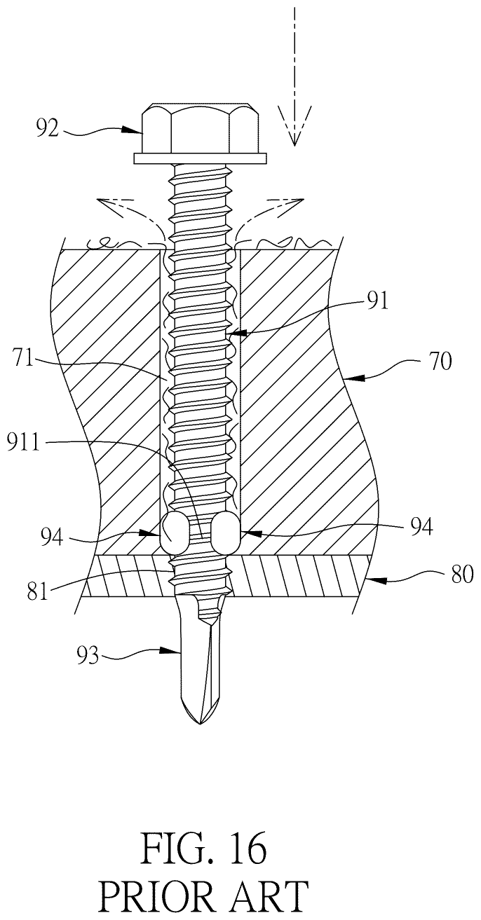

FIG. 17 is another cross-sectional view showing the operation of the conventional self-drilling screw.

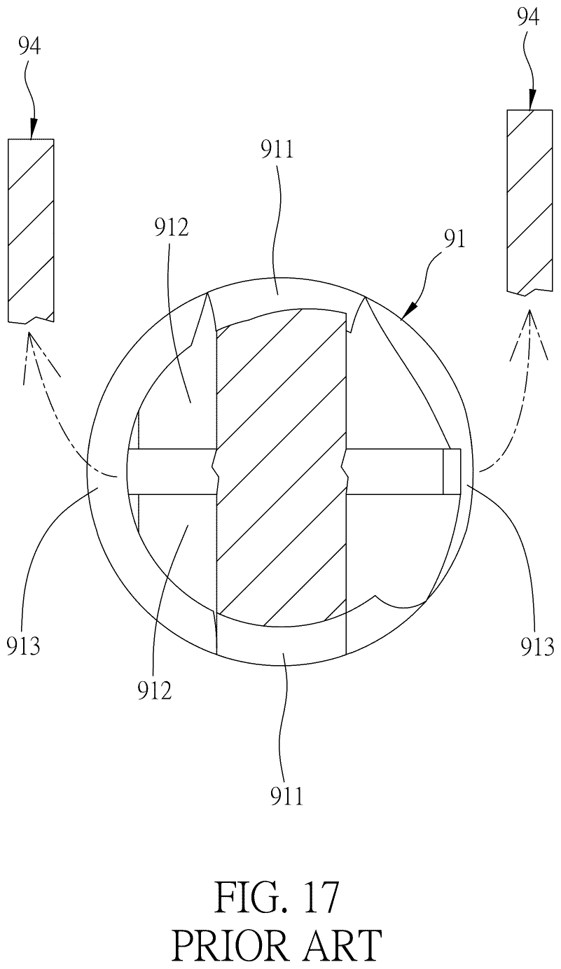

FIG. 18 is also another cross-sectional view showing the operation of the conventional self-drilling screw.

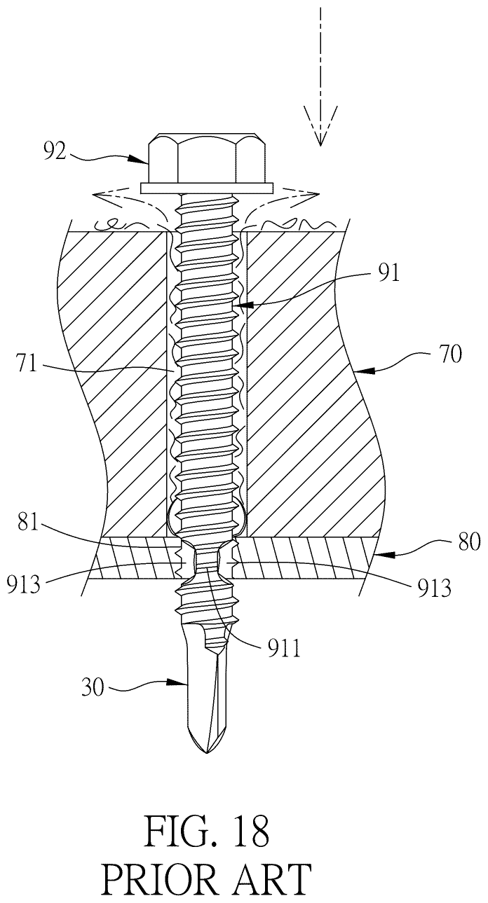

FIG. 19 is still another cross-sectional view showing the operation of the conventional self-drilling screw.

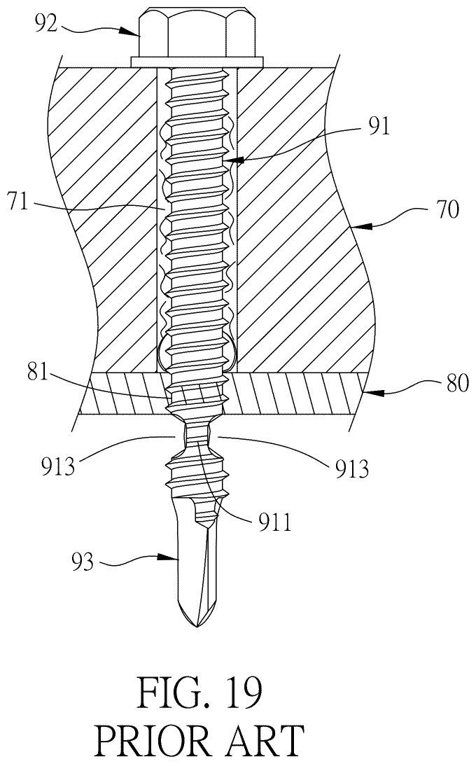

### DETAILED DESCRIPTION

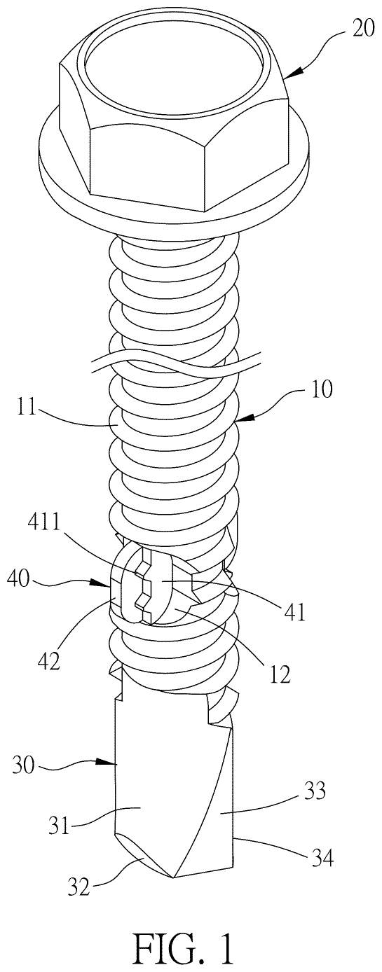

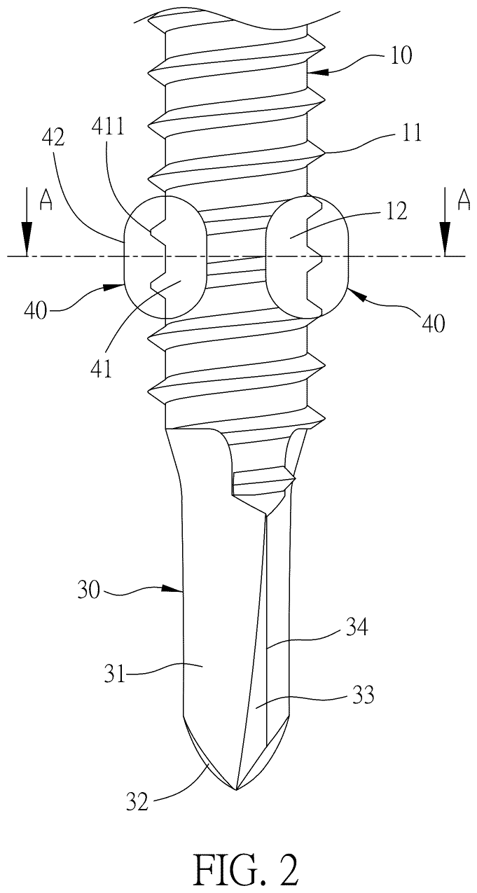

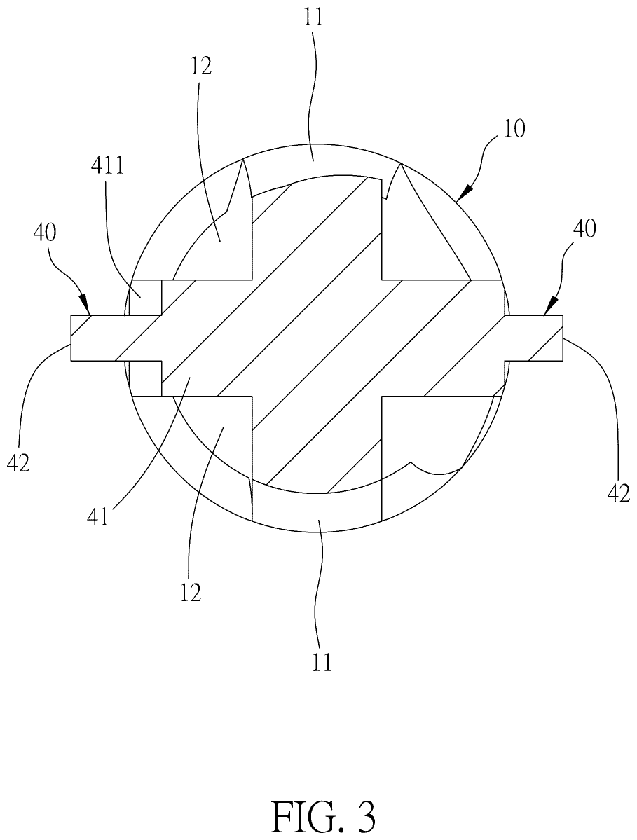

With reference to FIGS. 1-3, a self-drilling screw with at least one tab according to a preferred embodiment of the present invention comprises a stem 10, a screw head 20, a drill portion 30, and the at least one tab 40.

The stem 10 is formed in a circular column shape and includes a threaded section 11 formed on an outer wall of the stem 10.

The screw head 20 is formed on an end of the stem 10 and is connected with the threaded section 11.

The drill portion 30 is formed on the other end of the stem 10 and is connected with the threaded section 11, and the drill portion 30 includes a body 31 connected with the stem 10, a drilling edge 32 formed on an end of the body 31, two discharge grooves 33 defined on the body 31 and spaced on two opposite sides of the cut edge 32, and a cutting edge 34 formed on a connection area of the two discharge grooves 33 and the body 31.

The at least one tab 40 is located on the stem 10 adjacent to the drill portion 30 and the threaded section 11, the stem 10 includes two indentations 12 formed on two sides of each tab 40 of the at least one tab 40, wherein the threaded section 11 is defined among the at least one tab 40, the screw head 20, and the drill portion 30, wherein each tab 40 further includes a thicker sheet 41 which has multiple auxiliary teeth 411 formed on a side of the thicker sheet 41 away from the stem 10 and connected with a thinner flange 42, wherein a profile of the multiple auxiliary teeth 411 corresponds to a profile of the threaded section 11, and the multiple auxiliary teeth 411 are spaced by the threaded section 11. In this embodiment, a number of the at least one tab 40 is two, and the two tabs 40 are located on two sides of the stem 10 proximate to the drill portion 30, wherein the two tabs 40 are oppositely located on the two sides of the stem 10, a thickness of the thicker sheet 41 is greater than a thickness of each flange 42, and each flange 42 is connected on a central position of a thickness of the thicker sheet 41.

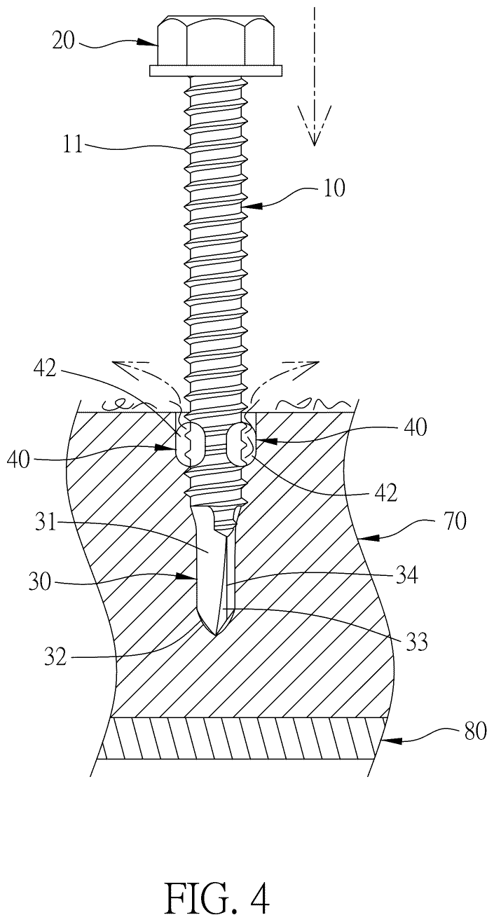

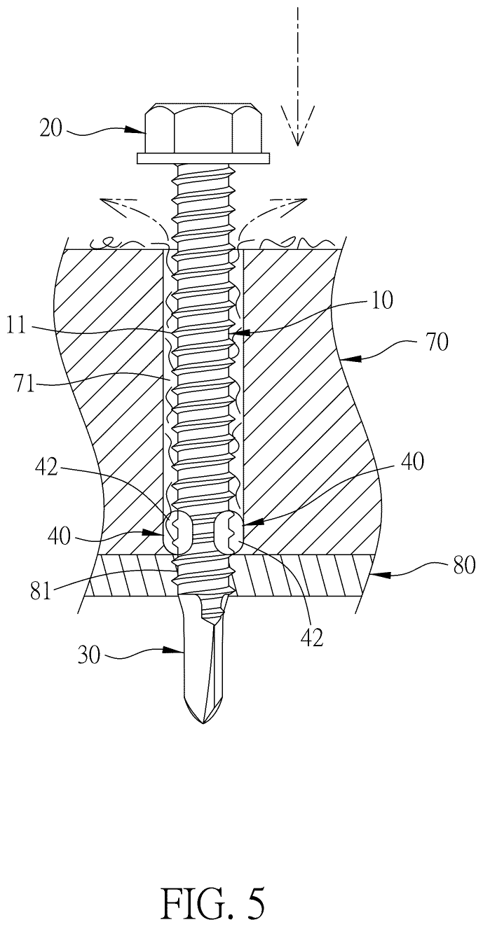

Referring to FIGS. 4 and 5, when the self-drilling screw is configured to lock a workpiece 70 made of wood (however, the self-drilling screw is configured to lock the workpiece made of flexible material, such as acrylic or plastic) with another workpiece 80 made of metal (replaceable for rigid material), the drill portion 30 is biased against the workpiece 70 and the screw head 20 is rotated to drive the drill portion 30 to drill a bore on the workpiece 70, such that the drilling edge 32 and the cutting edge 34 drill and cut the workpiece 70, and cut chips are discharged from the two discharge grooves 33 to produce a locking orifice 71, then the two tabs 42 moves into the locking orifice 71 to enlarge the locking orifice 71 with the drill portion 30, thus moving the threaded section 11 into the locking orifice 71 smoothly. When the drill portion 30 moves into the workpiece 70 and drills another workpiece 80, a fixing orifice 81 is produced so that the threaded section 11 taps the fixing orifice 81.

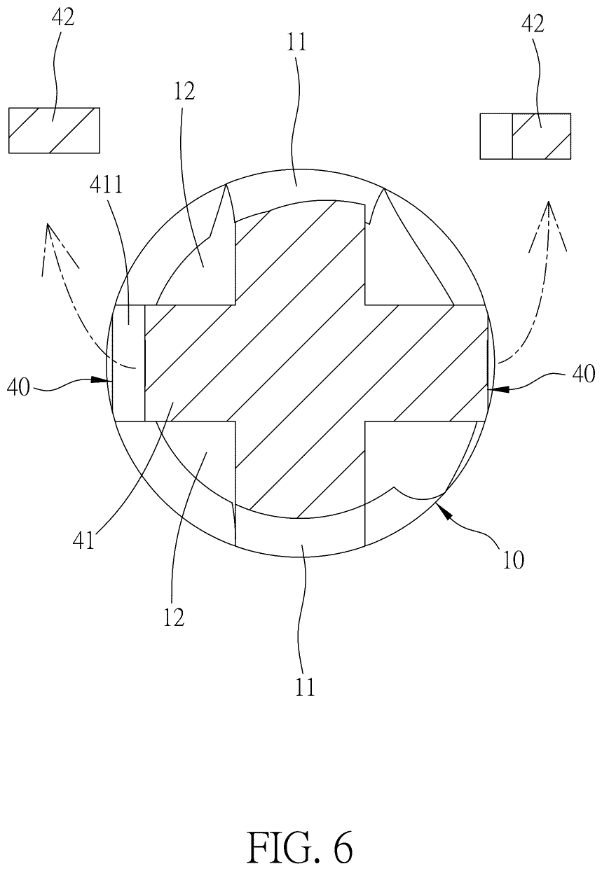

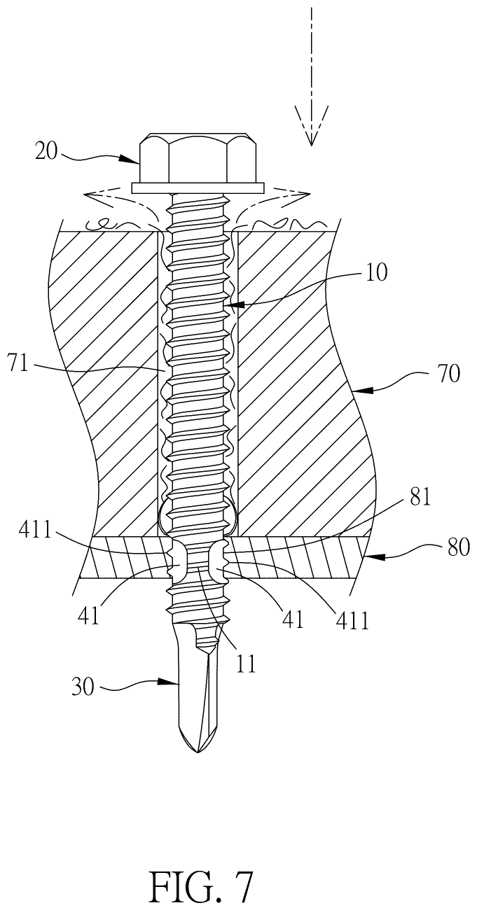

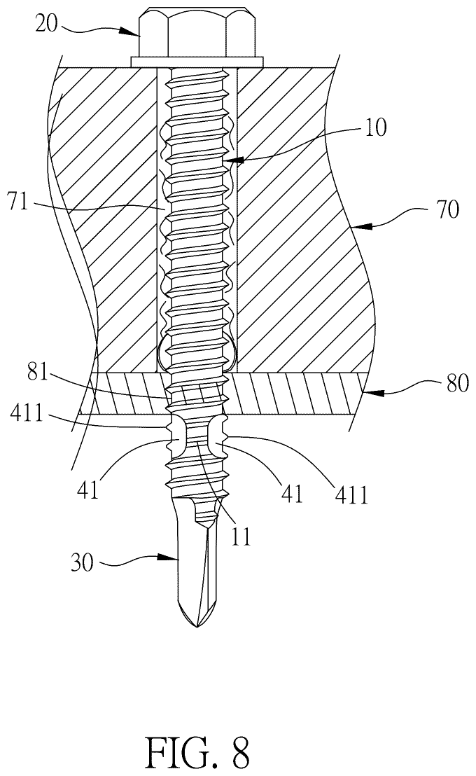

When the two tabs 42 contact with another workpiece 80, as shown in FIGS. 6-8, the two tabs 42 are stopped to break so that the multiple auxiliary teeth 411 of the thicker sheet 41 expose outside, and the multiple auxiliary teeth 411 and the threaded section 11 drill continuously to avoid producing a non-threaded zone over 90 degrees, hence the self-drilling screw taps the fixing orifice 81 until the screw head 20 abuts against the workpiece 70 matingly, thus connecting the workpiece 70 to another workpiece 80.

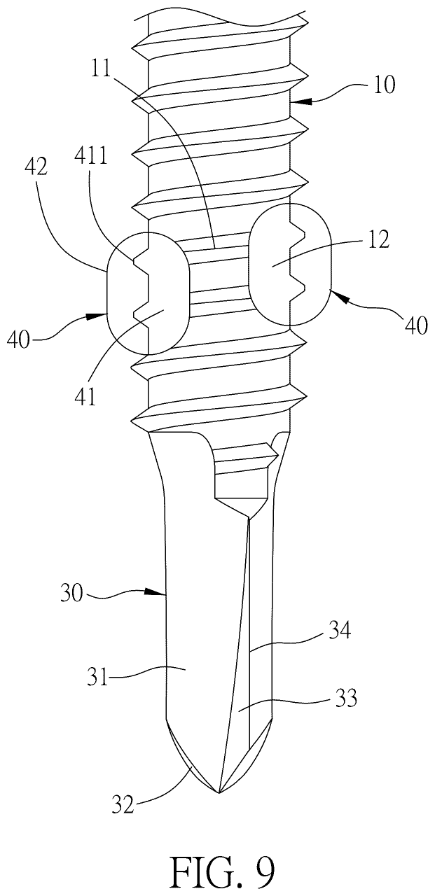

As illustrated in FIG. 9, in another preferred embodiment, a number of the at least one tab 40 is two, and the two tabs 40 are staggered.

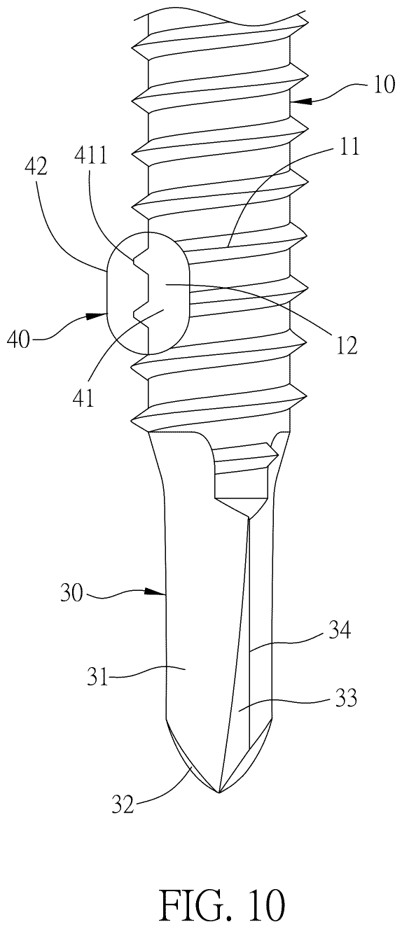

With reference to FIG. 10, in another preferred embodiment, a number of the at least one tab 40 is one, and the one tab is located on a side of the stem 10 adjacent to the drill portion 30.

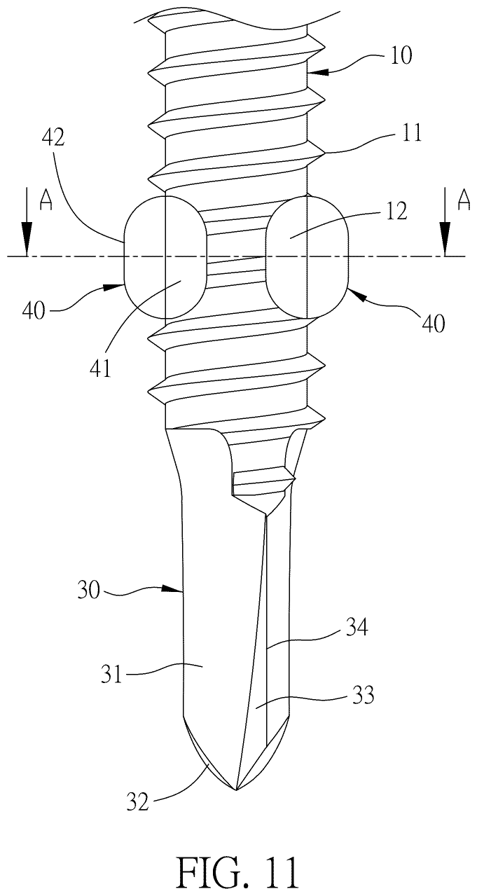

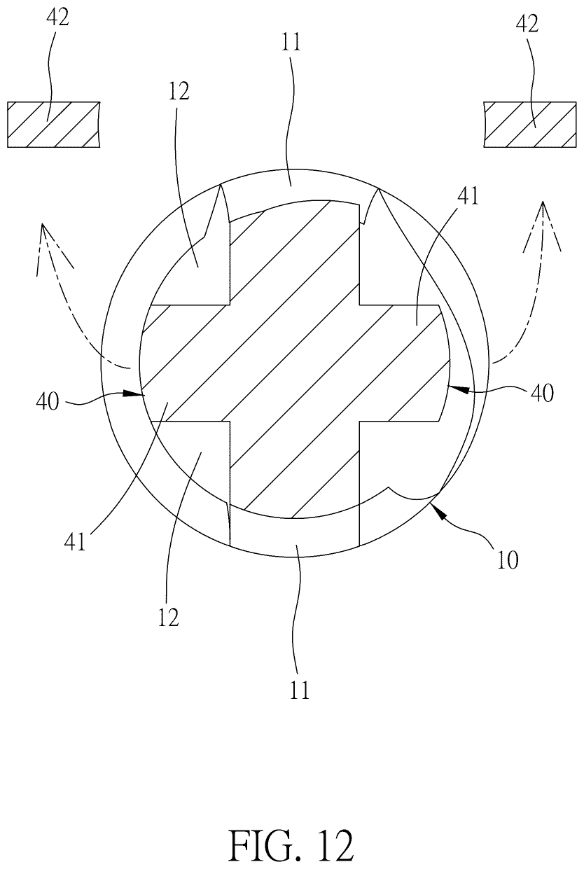

Referring to FIGS. 11 and 12, in another preferred embodiment, each tab 40 includes a thicker sheet 41, and the thick sheet 41 has a thinner flange 42 formed on a side thereof away from the stem 10, wherein a thickness of the thicker sheet 41 is greater than a thickness of the thinner flange 42, and the thinner flange 42 is connected on a central position of the thicker sheet 41, a distance from a connection area of the thicker sheet 41 and the thinner flange 42 to a center of the stem 10 is equal a distance from a root of the threaded section 11 to the center of the stem 10.

Accordingly, the self-drilling screw has the following advantages:
1) The at least one tab 40 is located on the stem 10 adjacent to the drill portion 30 and the threaded section 11, wherein each tab 40 further includes the thicker sheet 41 which has multiple auxiliary teeth 411 formed on the side of the thicker sheet 41 away from the stem 10 and connected with the flange 42, when the workpiece 70 made of the wood is connected with another workpiece 80 made of the metal, the flange 42 is broken so that the multiple auxiliary teeth 411 of the thicker sheet 41 expose outside, and the multiple auxiliary teeth 411 and the threaded section 11 drill continuously to reduce a screwing difficulty, shorten a screwing force and time, and enhance working efficiency.
2) After the flange 42 is broken, the multiple auxiliary teeth 411 of the thicker sheet 41 expose outside and drill the workpieces 70, 80 continuously with the threaded section 11, hence the thicker sheet 41 and the multiple auxiliary teeth 411 contact with the workpieces 70, 80 matingly to prevent a tilted drilling of the workpieces 70, 80, thus enhancing a screwing stability and avoiding an unexpected danger.

While the first embodiments of the invention have been set forth for the purpose of disclosure, modifications of the disclosed embodiments of the invention as well as other embodiments thereof, may occur to those skilled in the art. The scope of the claims should not be limited by the first embodiments set forth in the examples, but should be given the broadest interpretation consistent with the description as a whole.

What is claimed is:

1. A self-drilling screw with at least one tab comprising:
a stem (10) including a threaded section (11) formed on an outer wall of the stem (10);
a screw head (20) formed on an end of the stem (10);
a drill portion (30) formed on the other end of the stem (10); and
at least one tab (40) located on the stem (10) adjacent to the drill portion (30) and the threaded section (11), and the stem (10) including two indentations (12) formed on two sides of each tab (40) of the at least one tab (40), wherein each tab (40) further includes a thicker sheet (41) which has multiple auxiliary teeth (411) formed on a side of the thicker sheet (41) away from the stem (10) and connected with a thinner flange (42), wherein a profile of the multiple auxiliary teeth (411) corresponds to a profile of the threaded section (11), and the multiple auxiliary teeth (411) are spaced by the threaded section (11).

2. The self-drilling screw as claimed in claim 1, wherein a number of the at least one tab (40) is two, and the two tabs (40) are located on two sides of the stem (10) proximate to the drill portion (30), wherein the two tabs (40) are oppositely located on the two sides of the stem (10).

3. The self-drilling screw as claimed in claim 1, wherein a number of the at least one tab (40) is two, and the two tabs (40) are located on two sides of the stem (10) proximate to the drill portion (30), wherein the two tabs (40) are staggered.

4. The self-drilling screw as claimed in claim 1, wherein a thickness of the thicker sheet (41) is greater than a thickness of each flange (42), and each flange (42) is connected at a central position of a thickness of the thicker sheet (41).

5. The self-drilling screw as claimed in claim 2, wherein a thickness of the thicker sheet (41) is greater than a thickness of each flange (42), and each flange

(42) is connected at a central position of a thickness of the thicker sheet (41).

6. The self-drilling screw as claimed in claim 3, wherein a thickness of the thicker sheet (41) is greater than a thickness of each flange (42), and each flange (42) is connected at a central position of a thickness of the thicker sheet (41).

7. A self-drilling screw with at least one tab comprising:
a stem (10) including a threaded section (11) formed on an outer wall of the stem (10);
a screw head (20) formed on an end of the stem (10);
a drill portion (30) formed on the other end of the stem (10); and
at least one tab (40) located on the stem (10) adjacent to the drill portion (30) and the threaded section (11), and the stem (10) including two indentations (12) formed on two sides of each tab (40) of the at least one tab (40), wherein each tab (40) further includes a thicker sheet (41), the thick sheet (41) has a thinner flange (42) formed on a side thereof away from the stem (10), wherein a distance from a connection area of the thicker sheet (41) and the thinner flange (42) to a center of the stem (10) is equal a distance from a root of the threaded section (11) to the center of the stem (10).

8. The self-drilling screw as claimed in claim 7, wherein a number of the at least one tab (40) is two, and the two tabs (40) are located on two sides of the stem (10) proximate to the drill portion (30), wherein the two tabs (40) are oppositely located on the two sides of the stem (10).

9. The self-drilling screw as claimed in claim 7, wherein a number of the at least one tab (40) is two, and the two tabs (40) are located on two sides of the stem (10) proximate to the drill portion (30), wherein the two tabs (40) are staggered.

10. The self-drilling screw as claimed in claim 7, wherein a thickness of the thicker sheet (41) is greater than a thickness of each flange (42), and each flange (42) is connected at a central position of a thickness of the thicker sheet (41).

11. The self-drilling screw as claimed in claim 8, wherein a thickness of the thicker sheet (41) is greater than a thickness of each flange (42), and each flange (42) is connected at a central position of a thickness of the thicker sheet (41).

12. The self-drilling screw as claimed in claim 9, wherein a thickness of the thicker sheet (41) is greater than a thickness of each flange (42), and each flange (42) is connected at a central position of a thickness of the thicker sheet (41).
